(19) United States
(12) Patent Application Publication
(10) Pub. No.: US 2022/0188322 A1
(43) Pub. Date: Jun. 16, 2022

(54) METHOD AND SYSTEM OF DATABASE ANALYSIS AND COMPRESSION

(71) Applicant: Michael E. Adel, Ness Ziona (IL)

(72) Inventor: Michael E. Adel, Ness Ziona (IL)

(21) Appl. No.: 17/686,715

(22) Filed: Mar. 4, 2022

Related U.S. Application Data
(63) Continuation-in-part of application No. PCT/IL2020/050968, filed on Sep. 3, 2020.
(60) Provisional application No. 62/895,513, filed on Sep. 4, 2019.
(60) Provisional application No. 63/293,085, filed on Dec. 23, 2021.

(51) Int. Cl. G06F 16/2457; G06F 16/242; G06F 16/28

(52) U.S. Cl. CPC G06F 16/24578; G06F 16/287; G06F 16/244

(57) ABSTRACT

In an embodiment, a system includes at least one computing device and program instructions stored on a non-transitory computer readable medium. The program instructions, when executed by the at least one computing device, cause the at least one computing device to receive input data in the form of at least one search criterion indicative of a data landscape, query an electronic database based at least in part on the input data, retrieve a data list from the electronic database based at least in part on the query, count data with common player names from the data list, sort by count to generate a discrete distribution, apply power law analysis to the discrete distribution to determine the value of an exponent S of the discrete distribution and use the exponent S as a metric of consolidation of the data list. Said exponent may then be stored in a lossy compressed database.

### CROSS-REFERENCE TO RELATED APPLICATIONS

This application is a continuation-in-part of International Patent Application No. PCT/IL2020/050968, filed on Sep. 3, 2020, which claims the benefit of U.S. Provisional Application No. 62/895,513, filed on Sep. 4, 2019, the entire contents of which are incorporated herein by reference. This application also claims the benefit of U.S. Provisional Application No. 63/293,085, filed on Dec. 23, 2021, the entire content of which is incorporated herein by reference.

### BACKGROUND OF THE SPECIFICATION

The present disclosure relates methods and systems for database compression. A database landscape analysis method and system are disclosed which enable drastically reduced computational resources in real-time or quasi real-time in order to provide actionable insight regarding the database landscape.

### SUMMARY

A database landscape can be defined as a portfolio of database elements which meet a specific search criterion. The invention is particularly applicable to publication landscapes.

In an embodiment, the need to load and search the whole database is obviated by relying on a method of lossy compression based on power law transformation of Pareto distributions, in order to extract a combination of any one, two or all three of the metrics of scale, consolidation and/or top ranked player dominance of a database landscape. In a further embodiment, the time evolution of the database landscape is calculated and may be visualized either statically or dynamically in real-time or quasi real-time by virtue of the computational efficiency of the method.

In some embodiments, an element may refer to a database entry which may be associated with multiple data fields which characterize the element. By way of example, if the database is a database of publications such as patent publications, an element may refer to a particular publication and the associated data fields may comprise, also by way of example, assignee, inventor, IPC code, etc. Furthermore, in this context, the term player refers to a particular entry in the associated data field.

In a further embodiment, analysis and visualization of element classification landscapes are described which provide insight into a combination of any one, two or all three of the metrics of scale, diversification and top ranked classification dominance.

In one embodiment, the method of analysis of a database landscape by a computing device includes the input of data in the form of at least one search criterion indicative of a database landscape; querying of a database, retrieval of an element list meeting said at least one criterion from said database; counting elements with common player names from said list and sorting by count to generate a discrete distribution; applying power law analysis to said discrete distribution to determine the value of an exponent S of said discrete distribution and using said exponent S as a metric of consolidation of said database landscape. This method may then be iterated over a subset or all of the elements of the database in order to produce a highly compressed dataset compared with the source database. The method may also be iterated over multiple player types in the database so that said metrics of either consolidation, scale or dominance may be subsequently extracted for a specified player type and individual player by accessing a highly compressed database, resulting in improvements in speed, efficiency and flexibility in terms of data location and availability of resources. The method allows reductions in storage hardware, data transmission time and communication bandwidth.

In one example, a Pareto, i.e. a ranked array of element counts per player is fitted to a power law distribution of count versus rank. The exponent of the power law can be fixed, for example, to minus unity, or may vary. One approach to estimate both or either of the entitlement of the top ranked player and a metric of consolidation is to allow the exponent to float. In this approach we shall denote the element count for player of rank R to be C_{R} and the top ranked player's element count entitlement as C₁. In a frequency versus rank distribution these parameters are related by equation (1):

C_{R}=C₁R^{-s} (1)

where S is the exponent of the distribution. Applying a natural logarithm yields the following linear equation (2):

logₑC_{R}=logₑC₁−S logₑR (2)

For a given database landscape with observed element count distribution C₁ . . . Cₙ, for ranked players 1 to n, the system is overdetermined and we may apply, for example, a simple least squares method to determine the estimators for the exponent and top rank player element count. In an alternative embodiment, a more generalized or continuous power law distribution model may be applied, for example, using equation (3):

$${C}_{R} = \frac{S - 1}{{R}_{min}} {( \frac{R}{{R}_{min}} )}^{- S} \qquad ( 3 )$$

In which the exponent S may be estimated using the maximum likelihood estimator (MLE) found in equation (4):

$$S = 1 + n [ {Σ}_{i = 1}^{n} ln ( \frac{{R}_{i}}{{R}_{min}} ) ] \qquad ( 4 )$$

In a further embodiment, for each Rᵢ>Rₘᵢₙ, we estimate the exponent using the MLE and then we compute the Kolmogorov-Smirnov (KS) statistic for the data and the fitted model. Rₘᵢₙ is then estimated by choosing a value of Rᵢ for which the KS statistic is minimized.

Other mathematical fits such as beta or gamma functions may also be envisaged. In the particular case of the Pareto fit described above, there are two free parameters, the expectation value of the top ranked player element count, C₁ and the exponent expectation value, S. In one particular embodiment the database is a publication database, or more specifically a patent database. In this context the term “player” may take on various interpretations, including, but not limited to, the assignee, original assignee, inventor, authority, agency, publisher, owner, academic institution, author, country, city, journal, ORCID or other publication or industry identifier, etc. Other statistical estimation methods may alternatively be utilized including, e.g., orthogonal distance regression, chi square minimization or the Levenberg-Marquardt iterative method. As mentioned above, a constant may be introduced representing the logarithm of the expectation value of the top ranked player publication count. Other more generalized methods of parameter estimation may be used, as known in the art.

In some embodiments, the exponent of the power law distribution, S, may be used as an index of consolidation. In this context, the term consolidation refers to the concentration of the distribution of elements (for example publications) within the landscape. For example, landscapes with higher values of S may be considered consolidated or specialized, while landscapes with lower values may be considered fragmented or diversified. The rationale behind this assertion may be explained through consideration of the boundary cases of perfect fragmentation and perfect consolidation. In the case of a perfectly fragmented landscape, the elements would be equally distributed between the players. Such perfect fragmentation would produce a distribution of slope S equal to zero. In the converse case of a perfectly consolidated landscape, the whole portfolio would belong to a single dominant player and the slope S of the discrete Pareto distribution would tend to infinity. Given these two boundary cases, the exponent S may be effectively utilized as a metric of landscape consolidation according to illustrative embodiments, for example, as is illustrated in FIG. 1.

More specifically, for patent publication landscapes, S may vary from 0.2 to 2, with a typical boundary between consolidated versus fragmented landscapes set to unity, i.e. S=1.

An additional feature of the disclosed embodiments is the calculation and use of the expectation value of the top ranked player element count C₁ as a metric of landscape scale. Alternative metrics of scale may be the total count of elements for the first n ranked players, where n may vary from unity to the total number of players.

A further feature of the method is the use of the ratio of the expectation value of the top ranked player element count, C₁, to the actual top ranked player element count, C_{A}, as a metric of dominance of the top ranked player. More formally, it is stated that for a landscape of a given, finite number of elements, as the exponent rises, so will the expectation value of the top rank player's element count entitlement, C₁. If we therefore wish to quantify the dominance of the position of the top ranked player, we should normalize their actual element count by the expectation value of their element count. Algebraically, the dominance factor (D) can be defined by equation (5):

D=C_{A}/C₁ (5)

In some embodiments, this metric of dominance, D, of the top ranked player may be considered a metric of the landscape as a whole and not just a metric of the top ranked player's portfolio. This same metric may be applied to other ranked players.

In a further embodiment, the term player may refer to a classification type of elements in the database. By way of example, the classification could be a patent classification code such as IPC or CPC or any other known method of classifying patents. Alternately, the classification could be a scientific, bibliographic and bibliometric classification scheme such as those used in libraries or developed by companies such as Science-Metrix for classifying scientific publications. In further examples, the classification system could be classifying literature, scientific or otherwise, or website domains. In some embodiments, the player name may also or alternatively include an inventor name, country name, author name, country or jurisdiction of filing or publication.

Any one of the above-described embodiments may be applied to an arbitrarily large database in a preprocessing step in order to produce a distilled database, that is a drastically reduced size database which comprises metrics including, but not limited to scale, consolidation and dominance for players which may be queried in a subsequent real-time or quasi real-time fashion. By way of example, the size of a database comprising all bibliographic data for all published patent applications for the European Patent Organization (EPO) is larger than 100 GB in compressed form. By contrast a distilled database of metrics generated according to the illustrative embodiments described above may have a size in the order of 10 s to 100 s of MB, depending on the range of metrics and player types included in the distilled database, enabling a three to four order of magnitude reduction in storage capacity that is utilized to store the distilled database. Such a distilled database may be easily stored locally rather than by a cloud-based implementation due to its reduced size or may also or alternatively use less storage on such a cloud-based implementation, freeing up that storage space for other uses.

In an embodiment, a system is disclosed that comprises at least one computing device and program instructions stored on a non-transitory computer readable medium. The instructions, when executed by the at least one computing device, cause the at least one computing device to receive input data in the form of at least one search criterion indicative of a data landscape, query an electronic database based at least in part on the input data, retrieve a data list from the electronic database based at least in part on the query, count data with common player names from the data list, sort by count to generate a discrete distribution, apply power law analysis to the discrete distribution to determine the value of an exponent S of the discrete distribution and use the exponent S as a metric of consolidation of the data list.

In some embodiments, the metric is stored in a lossy compressed database version of the original electronic database. The program instructions may further cause the at least one processor to generate the lossy compressed database version based at least in part on the application of a compression algorithm to the data list. The compression algorithm may be based at least in part on a Pareto distribution. In another embodiment, the database is a publication landscape.

In another embodiment, at least one additional metric may determined where the at least one additional metric comprises one or more of a top ranked player dominance and a landscape scale. The at least one additional metric may be visualized graphically on a graphical display device. The visualization may comprise a graph in which on one axis the metric of landscape consolidation is plotted and on the other axis the metric of landscape scale is plotted. The metric of the landscape scale may be plotted logarithmically on the axis. In some embodiments, all three of the metrics may be visualized graphically. In an embodiment, the search criteria may include date ranges and the visualization may comprise a graph with one of the metrics on one axis and a date or time on the other axis. In another embodiment, the search criteria may include date ranges and the visualization may comprise a graph with one of the metrics on one axis and another of the metrics on a second axis.

In an embodiment, method of analysis of a database by a computing device is disclosed including receiving input data in the form of at least one search criterion indicative of a data landscape, querying an electronic database based at least in part on the received input data, retrieving a data list from the electronic database based at least in part on the query, counting data with common player names from the data list, sorting by count to generate a discrete distribution, applying power law analysis to the discrete distribution to determine the value of an exponent S of the discrete distribution and using the exponent S as a metric of consolidation of the database. In some embodiments, the database is a publication database.

In another embodiment, at least one additional metric is determined. The at least one additional metric comprises one or more of a top ranked player dominance and a landscape scale. The at least one additional metric may be visualized graphically on a graphical display device. The visualization may comprise a graph in which on one axis the metric of landscape consolidation is plotted and on the other axis the metric of landscape scale is plotted. The metric of landscape scale may be plotted logarithmically on the axis. In some embodiments, all three of the metrics may be plotted graphically.

The foregoing summary is illustrative only and is not intended to be in any way limiting. In addition to the illustrative aspects, embodiments, and features described above, further aspects, embodiments, and features will become apparent by reference to the drawings and the following detailed description. In the drawings, like reference numbers indicate identical or functionally similar elements.

### BRIEF DESCRIPTION OF THE DRAWINGS

The embodiments are herein described, by way of example only, with reference to the accompanying drawings, wherein:

FIG. 1 illustrates discrete Pareto distributions on a log log plot for Zipfian case of slope −1, and two extreme cases of slope 0 and −100 for element landscapes of equal element count (of 5187).

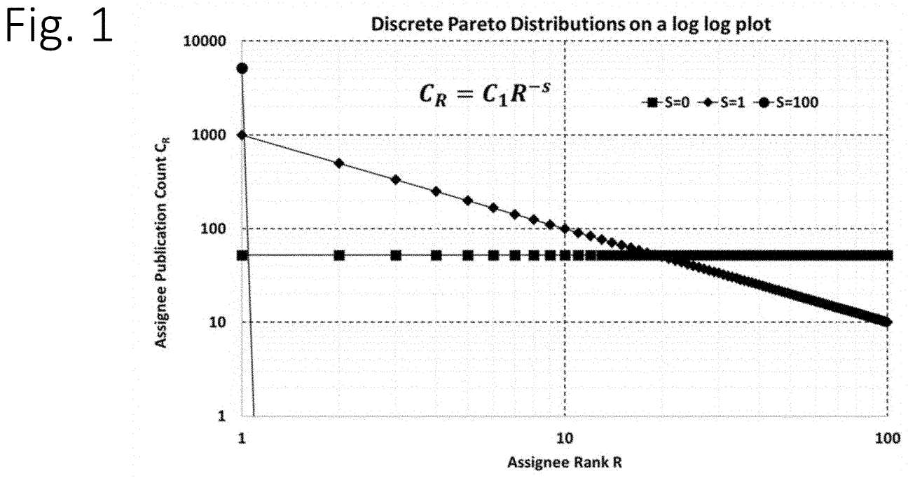

FIG. 2 is a log-log graph of assignee publication count vs rank of assignee for the lithography patent landscape, often termed a “Zipf plot”.

FIG. 3 is a log-linear graph of the Predicted top assignee publication count (C_{1f}) evolution over time for three patent landscapes.

FIG. 4 is a linear graph of the Dominance factor (D) evolution over time for three patent landscapes.

FIG. 5 is a linear graph of the Zipf plot exponent (S) evolution over time for three patent landscapes.

FIG. 6 is a log linear graph of the predicted top assignee count (C₁) vs the Zipf plot exponent (S) for three patent landscapes. This graph is also termed a “meta-landscape”.

FIG. 7 is a linear log graph of the predicted top assignee count (C₁) vs the Zipf plot exponent (S) for three patent landscapes. This graph is also termed a “meta-landscape”.

FIG. 8 is a log linear graph of the predicted top assignee count (C₁) vs the Zipf plot exponent (S) for three patent landscapes whereby the balloon size is scaled according to the Dominance factor (D).

FIG. 9 is a meta-landscape indicating quadrants which characterize the state of each landscape shown in the previous drawing.

FIG. 10 is a group of Zipf plots for the lithography landscape at different times.

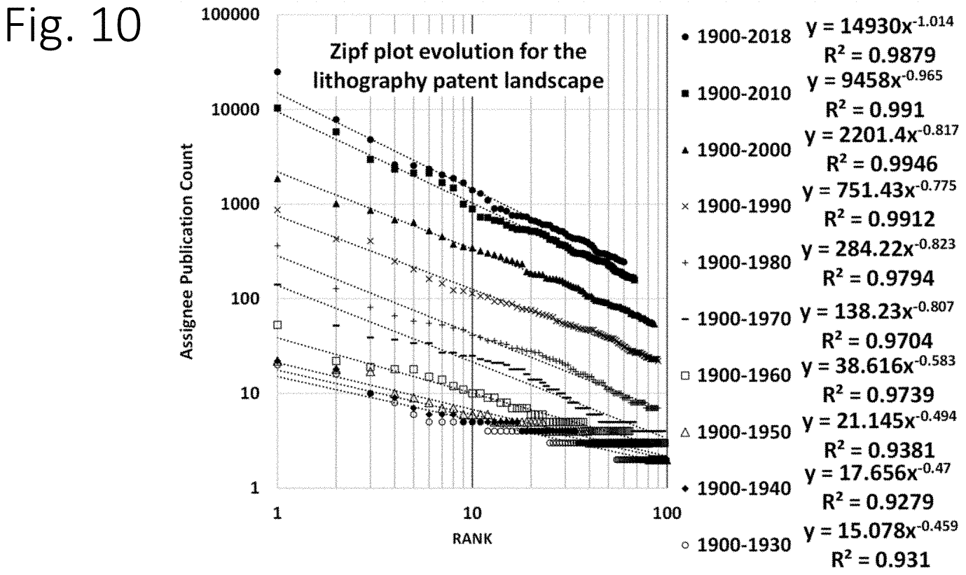

FIG. 11 is a log-log graph of classification publication count vs rank of classification for the Alphabet (aka Google) patent portfolio landscape of families filed in the last 2 years, often termed a “Zipf plot”.

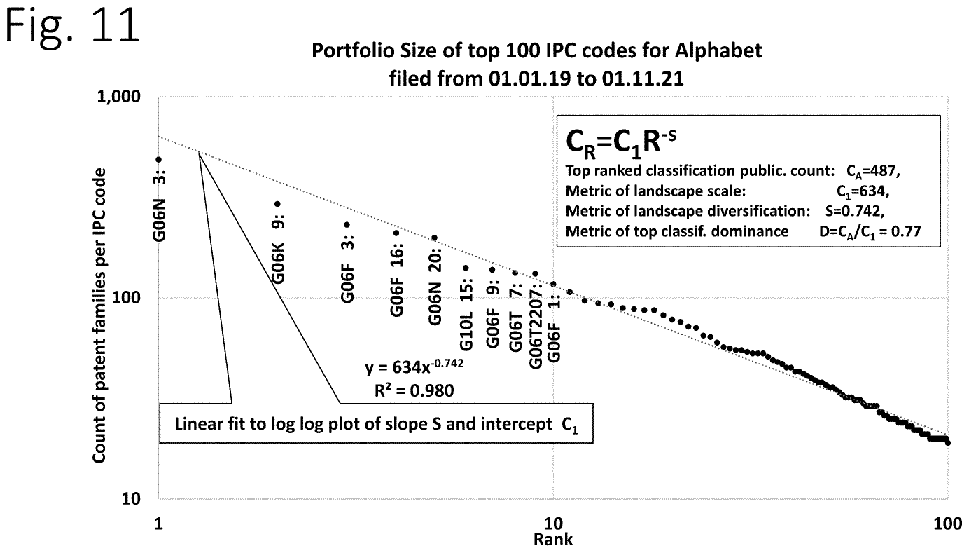

FIG. 12 is a log-linear graph of the predicted top classification publication count (C₁) evolution over time for the Alphabet patent classification landscape of all active families.

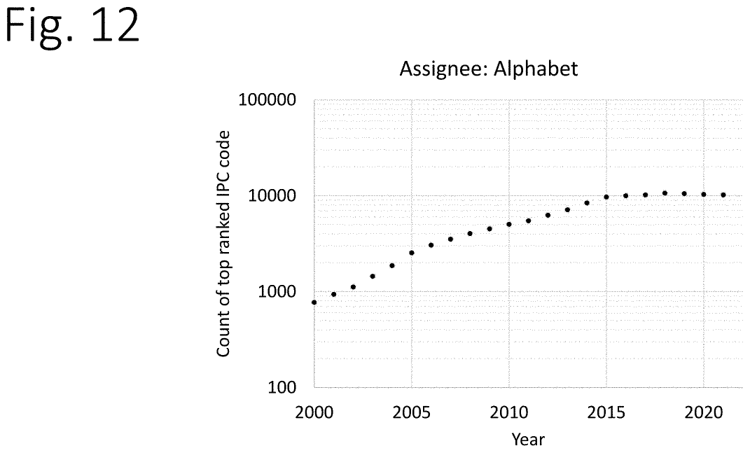

FIG. 13 is a linear graph of the Zipf plot exponent (S) evolution over time for the Alphabet patent classification landscape of all active families.

FIG. 14 is a linear graph of the Dominance factor (D) evolution over time for the Alphabet patent classification landscape of all active families.

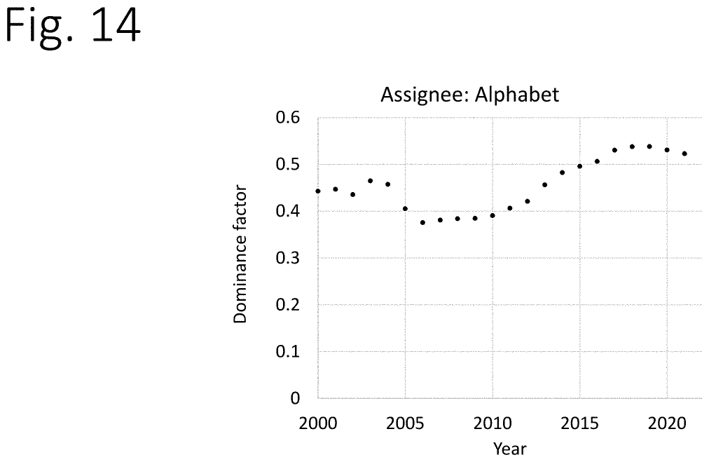

FIG. 15 is a log linear graph of the time evolution of the predicted top classification patent count (C₁) vs the Zipf plot exponent (S) for the Alphabet patent classification landscape of all active families, whereby the balloon size is scaled according to the Dominance factor (D).

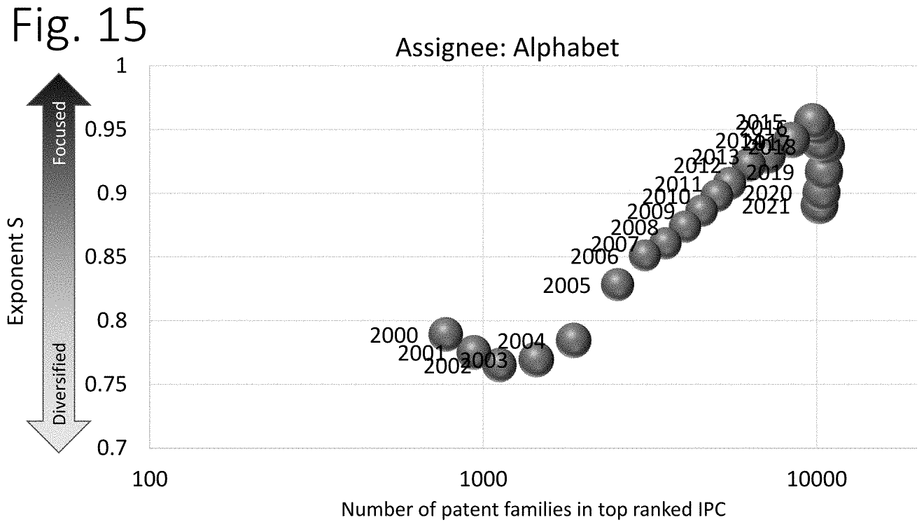

FIG. 16 is a log linear graph of the predicted top classification patent count (C₁) vs the Zipf plot exponent (S) for the patent classification landscape of multiple assignees for patent families filed in the last two years. This graph may also be termed a “classification meta-landscape”.

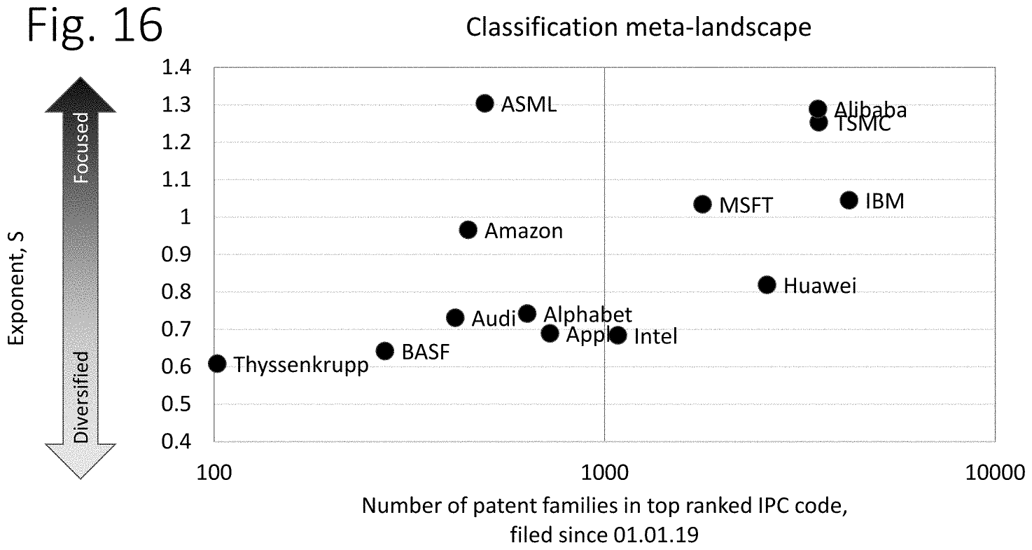

FIG. 17 is a log linear graph of the predicted top inventor patent count (C1) vs the Zipf plot exponent (S) for the inventor landscape of multiple assignees for patent families filed in the last two years. The location of the assignee in the meta-landscape is an indication of the innovation culture of the assignee.

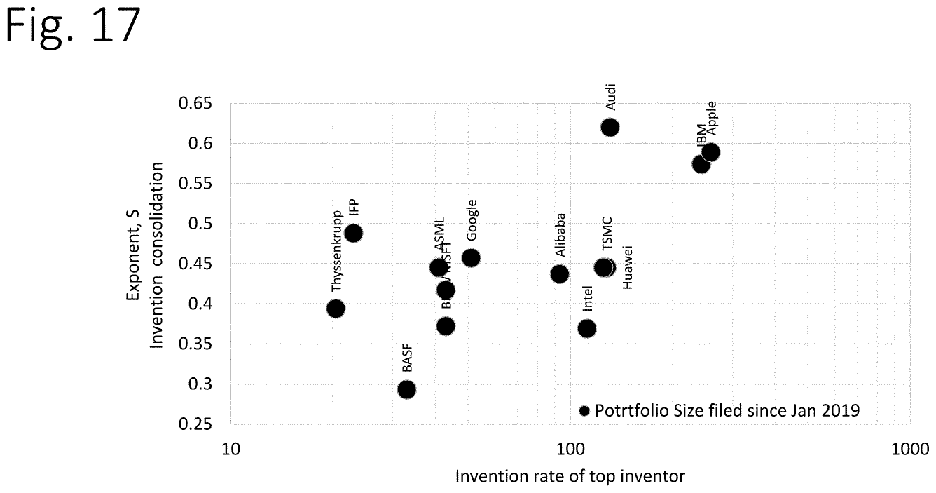

FIG. 18 is a log-log graph of patent classification publication count vs rank of classification for the inventor Michael E. Adel, which may be termed an “Inventor Zipf plot”.

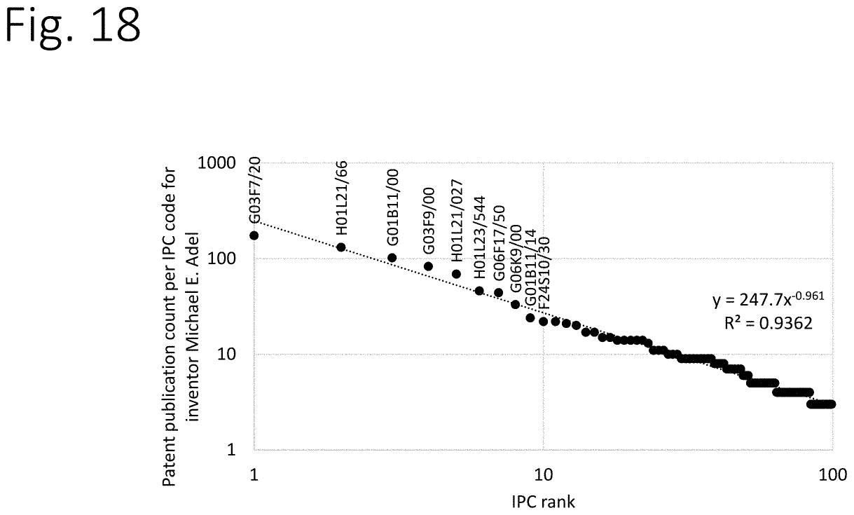

FIG. 19 is a log linear plot of cumulative publication count vs time for the lithography patent landscape.

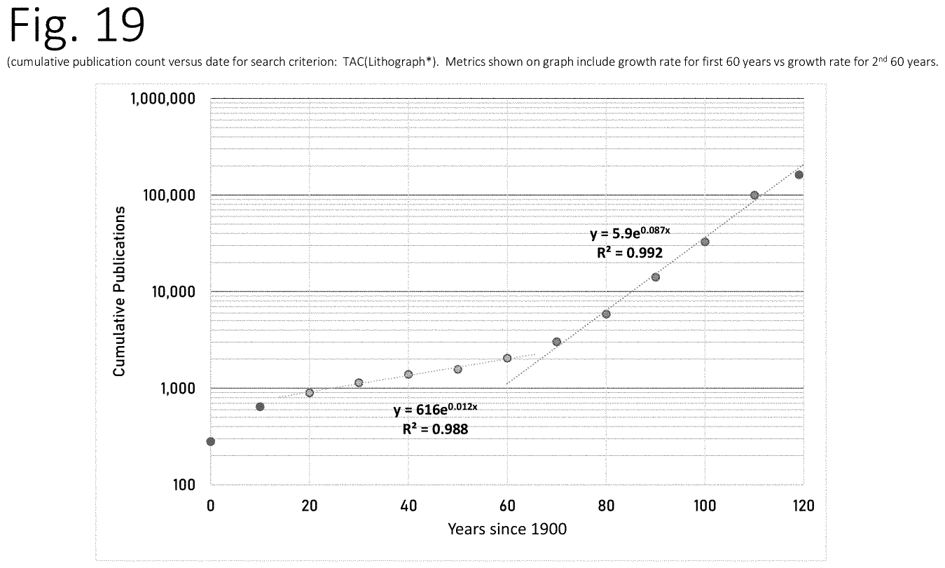

FIG. 20 is a diagram of a database analysis and compression system.

FIG. 21 is a flowchart of a method of lossy compression of a database.

FIG. 22 is a flowchart of a method of data landscape analysis and visualization.

### DETAILED DESCRIPTION

The disclosed embodiments will now be illustrated by means of an example with patent publication data illustrating graphically, the definition and extraction of the above-mentioned metrics. While this example clearly demonstrates an example implementation of the disclosed embodiments, it should not be considered as limiting and may be applied to other databases use cases.

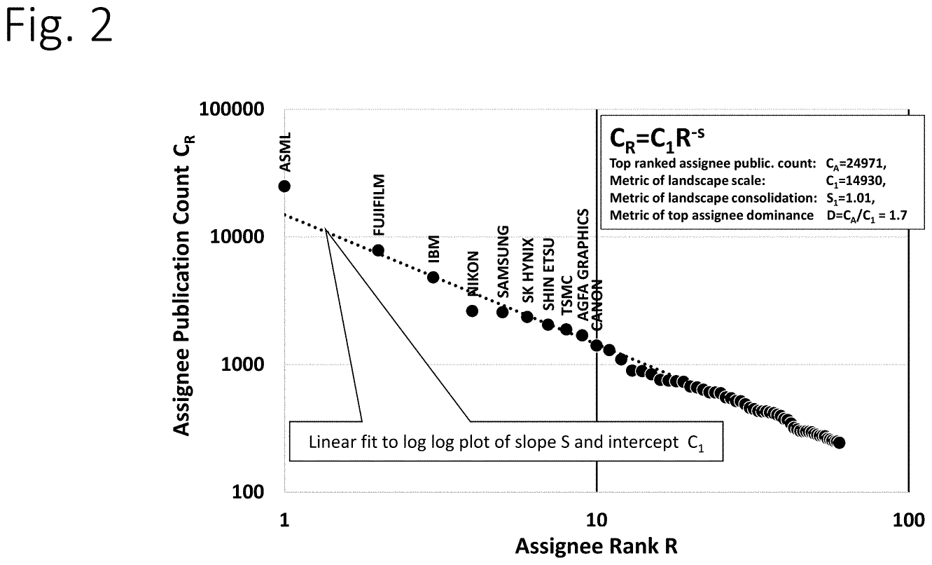

FIG. 2 shows an example lithography patent landscape, in which the publication (element) count is plotted versus the assignee (player) rank on a log-log plot, yielding a straight line to a good approximation. Such a plot may be referred to as a discrete Pareto plot, or a Zipf plot, after the American linguist George Kingsley Zipf who first observed that given some corpus of natural language utterances, the frequency of any word is inversely proportional to its rank in the frequency table, subsequently denoted as Zipf's law, as disclosed in Zipf, G. K. (1932). Selected studies of the principle of relative frequency in language. Harvard Univ. Press.

The three metrics extracted out of the discrete Pareto analysis methodology described above are useful for characterizing, both numerically and graphically, a database landscape and more specifically a patent landscape. The methods of characterization will now be described in further detail.

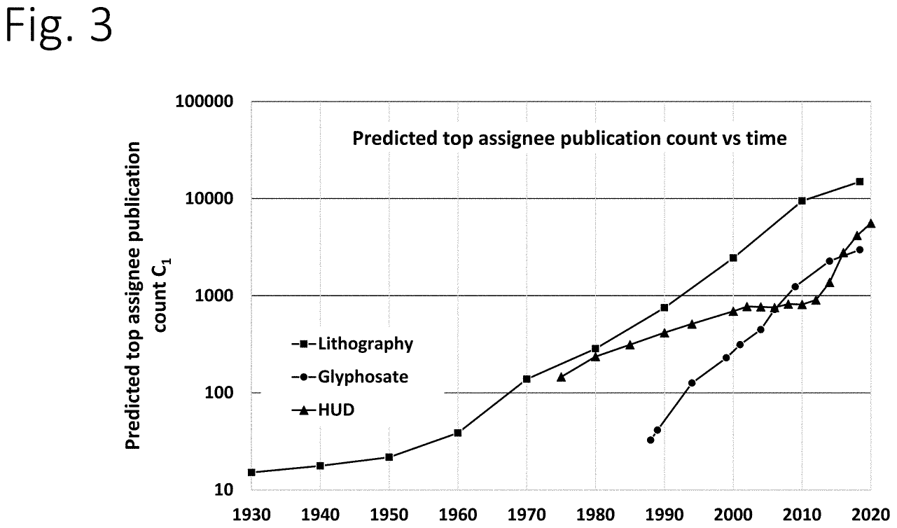

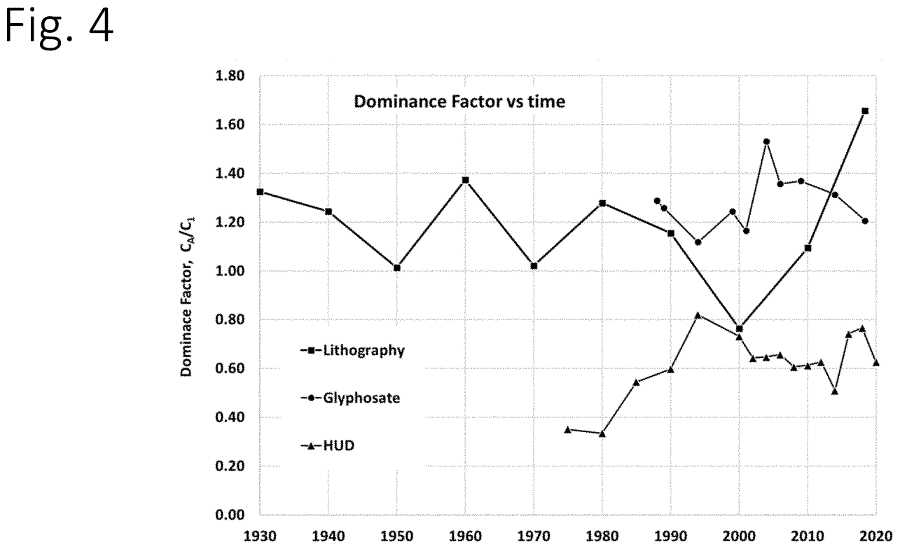

In an embodiment, the metrics may be calculated by the above-described methods for a sequence of search criteria, whereby the search criteria includes a set of publication date windows. By way of example, the publication window may have a fixed lower bound defined by the earliest date of publication and an upper bound which is incremented by a preset duration, such as one year, or the publication window duration can be fixed and moved in time. Such an approach can result in the visualization of a landscape temporal trajectory. For example, FIGS. 3, 4 & 5 display the time evolution of the metrics, C₁, D and S respectively, for three different search criteria. In these examples the three search criteria were set as:
1. TAC:(lithography OR lithographic) AND PBD:[19000101 TO XXXX0101]
2. TAC:(glyphosate) AND PBD:[19000101 TO XXXX0101]
3. (CPC:(GO2B 27/01) OR IPC:(G02B 27/01)) AND PBD:[19000101 TO XXXX0101]
   whereby TAC indicates that the term in brackets appears in the title, abstract or claims of the patent publication, CPC/IPC indicates the patent classification class (in this case GO2B 27/01 indicates head-up display) and XXXX indicates a year which is incremented to create the points in the respective graphs. The graphs may be linear, log-linear or log-log. These time-resolved trajectories tell the business stories behind the respective intellectual property spaces, in terms of scale, top ranked player dominance and consolidation. It should be appreciated that in an embodiment, the metrics of scale, consolidation and dominance are calculated in a preprocessing step, obviating the need to perform the full sorting, counting and modeling of the distribution in real-time or quasi-real-time as may be required for such visualization, drastically reducing the computational resource requirements.

With respect to date related information, an embodiment may also include methods of overcoming meta-landscape trajectory biases resulting from reliance on the current state of a database. By way of example, the current database may assign a subset of elements with original player B to player A, resulting from an acquisition of portfolio B by portfolio A.

Therefore, by way of example, if the element count is performed according one of the example search criteria 1, 2 and 3 mentioned above, the trajectory will not accurately reflect the state of the landscape in the past, prior to the above mentioned acquisition as it will indicate a higher level of consolidation than that which existed at the time by virtue of the attribution of the count of the merged component B to A's portfolio.

In a further embodiment, this problem may be overcome by maintaining and querying earlier, e.g., time-stamped, versions of the database when compiling time-resolved trajectories, rather than relying on restricting the query of the current database by publication date. In some embodiments, a merger table is constructed as an adjunct to the current database which specifies the merger/acquisition date when an element migrated between players. Using this additional information, an accurate historical state of the landscape can be reconstructed. In some embodiments, a lossy compression may be applied to the database periodically to generate a compressed database that may be maintained for future reference, providing the above mentioned benefits. In a further embodiment, data deduplication may be applied to the lossy compressed data base in order to reduce network traffic and further compress the time-stamped versions of the compressed database. Such deduplication may be achieved by either source, target, global or any other form of data deduplication known in the art.

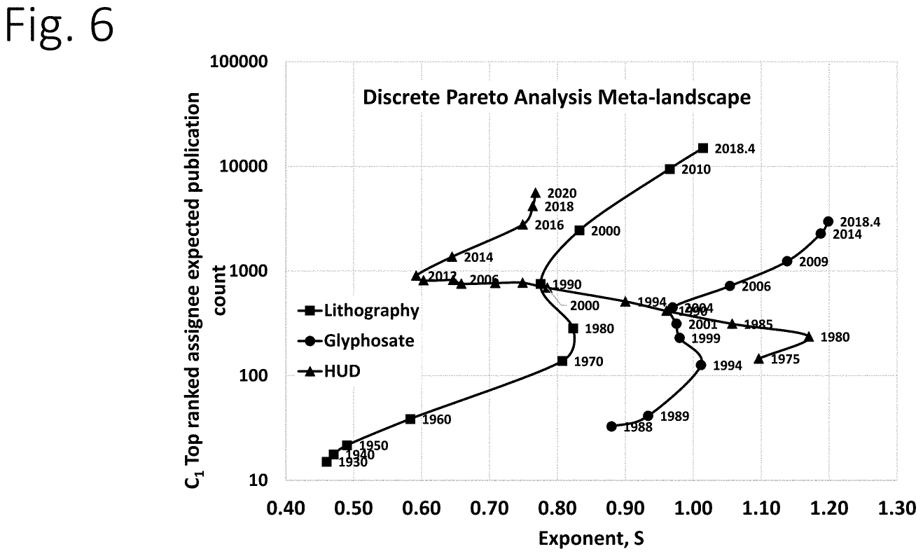

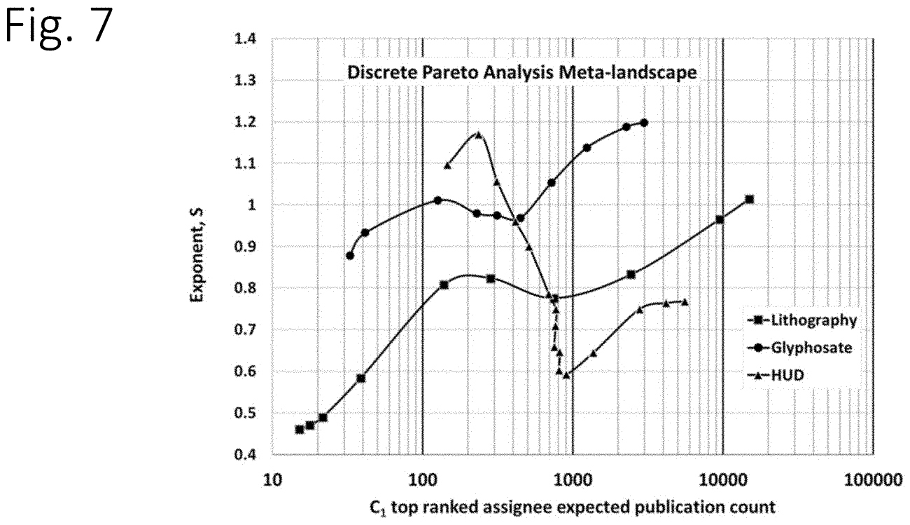

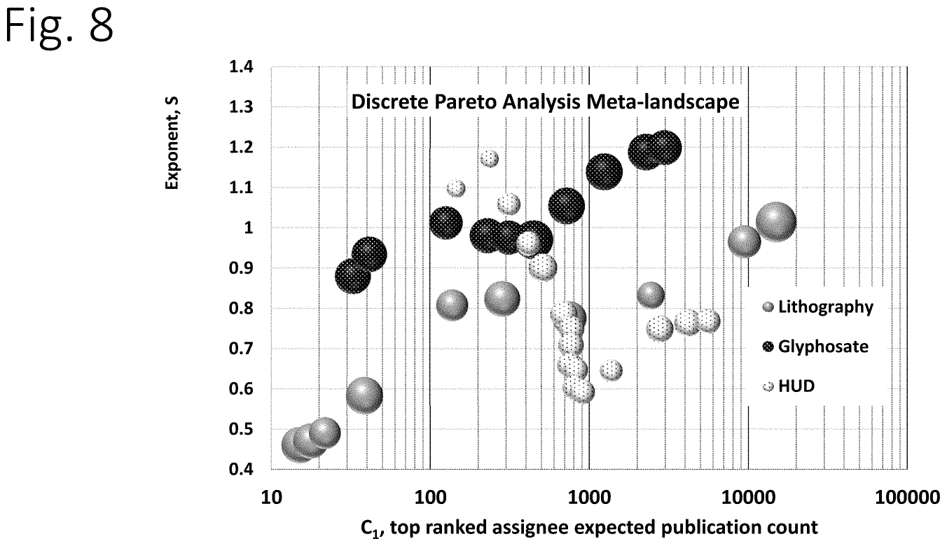

In an illustrative embodiment, the lossy compressed database may be used without accessing the original, uncompressed database for a number of applications. In an embodiment, the applications may include visualization of the compressed data in order to gain insight into the status of players in the database or to create meta-landscapes of the uncompressed database. The visualization of the meta-landscape may include information from two or even all three of the indices of scale, dominance and consolidation. For example, in one specific example, a metric of scale, e.g. the estimator of the element count of the top ranked player, C₁, is plotted on a log scale on the y-axis, and an index of consolidation, e.g., the exponent, S, is plotted on a linear scale on the x-axis. An example of such a meta-landscape is shown in FIG. 6 for the three above specified landscapes. An interesting feature of the so-called CS meta-landscape is the non-monotonic trajectory traversed by the different landscapes in the meta-landscape. In all three examples, it is noted that the landscape folds back on itself as the landscape grows while undergoing fragmentation, followed by a trajectory reversal after which the landscape consolidates. While this is indicated by way of example it is recognized that in other cases, such trajectory reversal may be absent. In one embodiment, elements in the CS meta-landscape are labeled with time or date labels as shown in FIG. 6. In the embodiment shown in FIG. 7, the metric of scale is plotted on the x-axis and the metric of consolidation on the y-axis. In this configuration, the slope of the graph, i.e. dS/dC₁ can be calculated which may be considered an indicator of landscape dynamic, i.e. an indicator of whether the landscape is consolidating or fragmenting. The landscape dynamic metric may be used or visualized in a way similar to any of the previously specified metrics. In FIG. 8, the meta-landscape incorporates three metrics, that of scale on the y-axis, consolidation on the x-axis and top player dominance, which is used to scale the balloons. Contrast or color of the marker may also be used to indicate the third metric. This may be termed a CSD meta-landscape. While the above mentioned examples generally refer to cases where the compressed database is used without access or reference to the original uncompressed database, this should not be considered limiting and a combination of data from both the compressed and original database for analysis and visualization may also be utilized.

In a further embodiment, the visualization may be implemented in a 3D space by virtue of the use of either virtual or augmented reality (VR or AR) display devices. In this case, the 3 spatial dimensions of the AR or VR display may be assigned to the 3 metrics of scale, dominance and consolidation, i.e., a 3D version of the CSD meta-landscape. In an alternative embodiment, 1 of the 3 spatial dimensions of the AR or VR display may be allocated to time, t (i.e. date) and the other 2 to any pair of the 3 metrics of scale, dominance and consolidation. These may be termed either CSt, CDt, SDt landscapes respectively. Any other allocations may alternatively be utilized.

In another visualization embodiment, multiple search criteria can be used to situate the current state (or at some other specified time) of multiple publication landscapes within any of the meta-landscapes specified in previous paragraphs. The search criterion may also specify legal or jurisdictional restrictions such as allowed or active patent publications or USPTO only.

In a further embodiment, rather than counting and ranking numbers of publications, a composite metric may be calculated which is partially dependent on the publication count but may include additional data which may reflect on the player's position in the field. One example of such a composite metric is the so called “Patent Asset Index” as described by Ernst et. al. in “The Patent Asset Index—A new approach to benchmark patent portfolios,” World Patent Information, 2010, in which the index includes additional quality metrics of the publication, which may indicate technology or market relevance, such as citation counts and GDP normalized geographical coverage. The index may then be used in a fashion similar to that of the publication count in the subsequent analysis. In another embodiment, rather than counting and ranking number of publications some other metric may be counted and ranked such as number of citations. Furthermore, said other metric may be a metric of value or cost which is stored in a database.

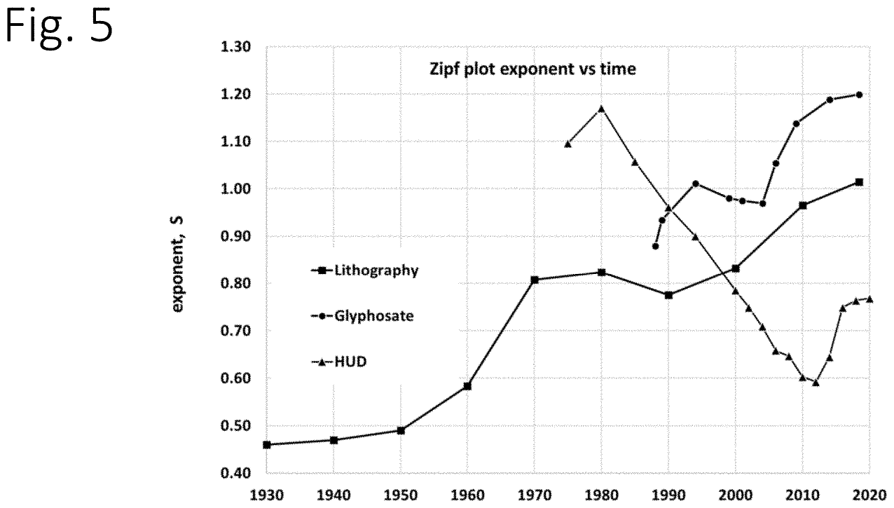

In another illustrative embodiment, of the method comprises a dynamic rather than static visualization. For example, referring to Error! Reference source not found., which displays a set of frequency ranked Paretos of assignee publication counts at incrementally longer or later publication periods, the Paretos may be introduced sequentially (for example at time steps of t where t may vary from 0.1 to 10 seconds). Additionally, in the said dynamic visualization, the trajectory of a given player in the Zipf plot over time may be highlighted by color, size, brightness or any other contrast mechanism. Such dynamic visualization may also be applied to data such as that shown in FIGS. 3 to 8 or to the AR or VR enabled 3D visualization mentioned above. In this embodiment in particular, the data compression aspect of the invention, that is the transformation of the full element database to a distilled metric set may be an enabler for real-time or quasi real-time dynamic visualization of the landscape trajectory. In this context, the distilled database may contain, as fields, said metrics or any combination of them. For example, in a database of search terms produced from a database of publications, fields of metrics of scale, consolidation and dominance or any combination of them can be used to characterize the search terms which nominally characterize a landscape or portfolio.

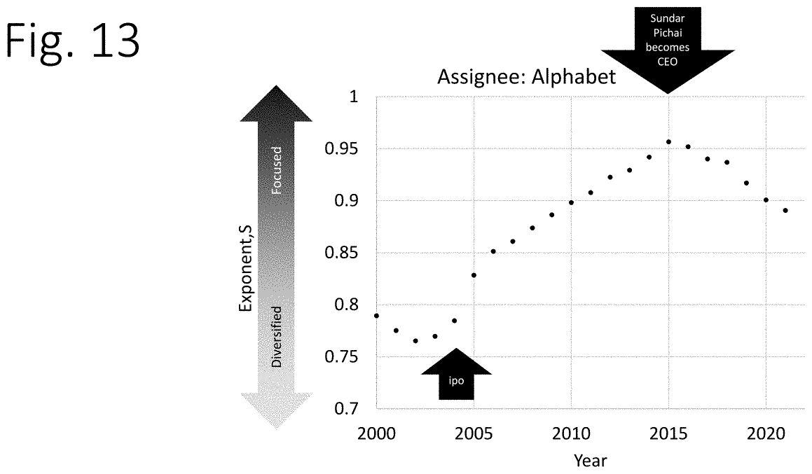

In a further embodiment, the lossy compressed database may also comprise metrics of growth rate of a given player. In this context the term rate may be used with reference to a time or date parameter or it may be used with reference to some other parameter in the database. By way of example, and as shown in FIG. 13, the growth rate may appear as an approximately linear regime in a semilog plot of publication count vs time as shown in equation (6).

$$C = {C}_{0} {e}^{\frac{t}{τ}} \qquad ( 6 )$$

where τ is the time constant of the exponential growth rate. Applying a natural logarithm yields the following linear expression of equation (7):

logₑC=logₑC₀+t/τ (7)

Regression methods, similar to those described above may be used to estimate the parameters C₀ and τ which are the count at t=0 and the exponential growth rate respectively. In some embodiments, the growth rate may be modelled as linear in time or date parameter or as a metric of a ratio with another parameter in the database. By way of example in the case of a patent publication database, the ratio of total publications to USPTO publications for all or a subset of players may be determined by regression and stored in the compressed database. It is noted that other mathematical relationships between the parameters of the database may exist and may be used in order to extract metrics of the original database and stored in the lossy compressed database.

In a further embodiment, such a compressed database, in conjunction with other independent metrics which characterize a landscape can be used as a training set for a machine learning (ML) algorithm, tasked, for example, with finding technology domains that are more likely to have attractive acquisition targets versus unassailable dominant players. In a further example, in a supervised ML algorithm case with the objective of identifying classifications of interest, the distilled metrics of historical datasets together with independent historical quality metrics of the classifications or players are used as training data. In the specific case of a patent publication database, again, by way of example, historical, independent data on stock exchange performance of a technology domain can be used as independent quality data which are provided to the ML algorithm together with the distilled metrics which are either contemporary with or prior to the stock exchange performance metrics. Such stock exchange metrics may include but should not be limited to stock price, price to earnings ratio, price earnings to growth ratio, free cash flow, price to book ratio or debt to equity ratio. While the above example relates to a supervised ML algorithm, semi supervised, unsupervised and reinforced ML algorithms should not be ruled out.

In a further embodiment in which the method is applied to a patent database, the player may be the inventor. The same mathematical metrics may then be reinterpreted to characterize the level of specialization of the specific landscape or for a particular player in a specific landscape or without restriction to a specific landscape.

In a further embodiment, the search criterion is systematically incremented or changed in order to visualize a large ensemble of metric data associated with a meta-landscape. By way of example, and in the case of patent landscapes, codes which classify publications according to domain of endeavor may be used (such as, e.g., IPC, UPC, GBC, F-Term, etc.) to span a broad domain. A single point can be plotted on the CS diagram for each sub-category to create a “heat diagram” showing density of points within the CS diagram. Such diagrams may also be displayed dynamically, as described above. In one particular embodiment of the heat diagram, all, or a subset of IPC codes are used iteratively as the search criterion for defining the landscape. Then, for each IPC code searched, a point is placed in the CS diagram. The heat diagram may then be color coded to indicate density of points in the meta-landscape. It is appreciated that the IPC code as an example of search criterion is in no way limiting and other ways to construct the heat diagram such as by search term or by date may also be envisaged.

In a further embodiment, the heat diagram may be a “gradient heat diagram” in which the gradient of the density of points in the CS diagram is plotted rather than the heat diagram itself. By way of example, the heat diagram is generated for two sequential date or time stamps and a quiver plot is generated to indicate the rate of change of the heat diagram as a function of location in CS space. In a further embodiment, the heat diagram may be visualized dynamically as a time or date stamp is incremented over time.

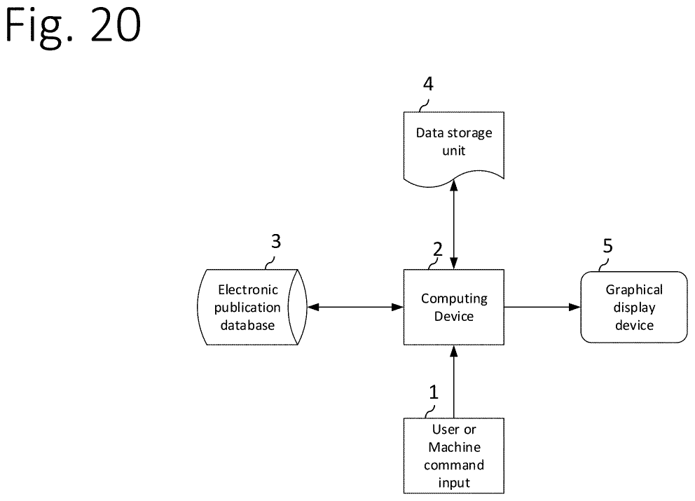

A system architecture of an illustrative embodiment will now be described with reference to FIG. 20. An input command is received, e.g., from user or machine, via a display interface 1 that is operable to control a graphical display device and provide the input to a computing device 2. Computing device 2 is configured to execute program instructions stored on a non-transitory computer readable medium and is communicatively coupled to an electronic publication database 3, a data storage unit 4 and a graphical display device 5. It is noted that the input command may be received via a network, rather than a display interface.

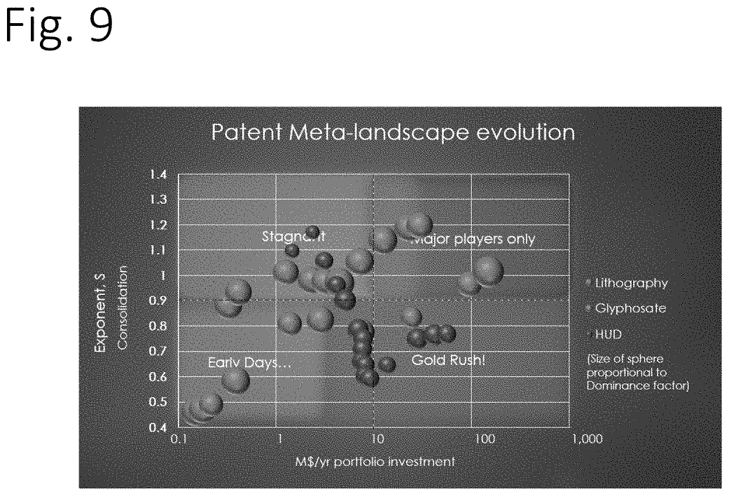

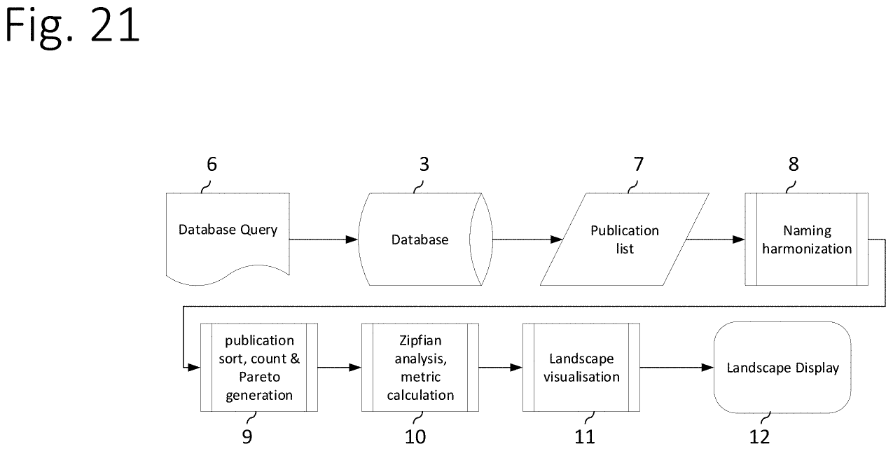

An example method according to an illustrative embodiment will now be described with reference to FIG. 21. A database query is executed at step 6, e.g., based on information or instructions contained in the input command, examples of which are shown in search criteria 1-3 mentioned above. A publication list is extracted from publication database 3 at step 7. In one embodiment, the publication list is then name harmonized at step 8, e.g., by methods known in the art. One example method of name harmonization is to sort the publication list alphabetically according to the player name (e.g. assignee name) and to harmonize names of players with minor typographical or punctuational variations. A distribution of publication counts is then generated at step 9 from the publication list by counting publications with common player names and the distribution is sorted in descending order by publication count. In an alternative embodiment, the name harmonization is performed subsequent to distribution generation and entries are combined and the distribution is resorted. At step 10, Zipfian analysis is performed in order to calculate metrics of scale, dominance and consolidation or any subset of the three. One method of performing said Zipfian analysis is according to equations (1)-(3) above. At step 11, landscape visualization is performed. By way of example, the visualization may take the form of any of the graphs shown in FIGS. 2-9. Said visualization may be either static or dynamic. In an optional step, said metrics may be stored in data storage unit 4. In a further optional step, said metrics may be retrieved from storage unit 4 and the above-described methods of visualization may be performed at a subsequent time. The landscape visualization is provided as a landscape display to the graphical display device 5 at step 12.

In some embodiments, the calculated indices may be used as metrics of quality of the search criterion. For example, discrete Pareto distributions with lower estimated exponents are more likely to result from search criteria which combine publications from players which are not necessarily in a competition with one another. This can be demonstrated by taking any two search criteria which result in two separate and distinct ensembles of players and combining them with an “OR” statement. Such “logical fragmentation” often results in a lower exponent than either of the two landscapes analyzed independently. Therefore, when comparing two candidate search criteria for the same landscape, the search criteria with the higher exponent, if the difference is significant, may be identified as a preferred search criteria for the landscape.

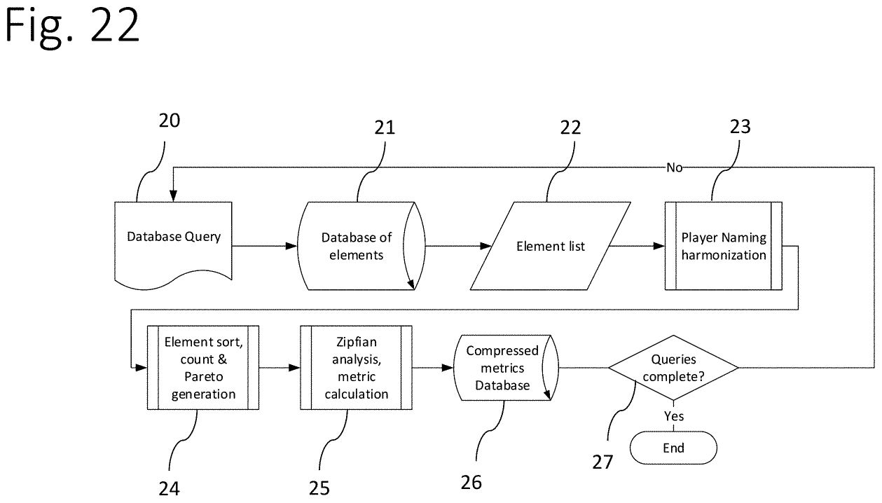

A further example method according to an illustrative embodiment will now be described with reference to FIG. 22. A database query is executed at step 20, e.g., based on information or instructions contained in the input command, examples of which are shown in search criteria 1-3 mentioned above. An element list is extracted from a database of elements 21 at step 22. In one embodiment, the element list is then player name harmonized at step 23, e.g., by methods known in the art. One example method of name harmonization is to sort the publication list alphabetically according to the player name (e.g. assignee name) and to harmonize names of players with minor typographical or punctuational variations. The elements are sorted, counted and a pareto distribution is generated at step 24 from the element list, e.g., by counting elements with common player names and the distribution is sorted in descending order by element count. In an alternative embodiment, the name harmonization is performed subsequent to distribution generation and entries are combined and the distribution is resorted. In a further embodiment, no name harmonization is performed. At step 25, Zipfian analysis is performed in order to calculate metrics of scale, dominance and consolidation or any subset of the three. One method of performing said Zipfian analysis is according to equations (1)-(3) above. At step 26, said metrics are stored in a compressed metrics database. At step 27, a determination is made of whether or not there are any additional queries. If all queries are completed, the method ends. If a query still needs to be executed, the method returns to step 20 and the method is repeated until all queries are complete in order to complete construction of the lossy compressed database. In a further optional step, said metrics may be retrieved from storage unit 4 and the above-described methods of visualization may be performed at a subsequent time. The landscape visualization is provided as a landscape display to the graphical display device 5, e.g., similar to that described above for step 12 of FIG. 21.

While the above examples are directed towards publications from an intellectual property database, the methods and systems found in the disclosed embodiments may also or alternatively be applied to any database including, but not limited to, trademarks, designs, scientific publications, books, blogs, advertisements, wiki pages, legal actions, website hits or any other database. In the context of the disclosed embodiments, the use of the term “publication” is not limited to publicly available databases and may include databases that not in the public domain. An example of such a “non-public” database may include a list of wiki pages or web pages or any other internal data set in which players may compete for dominance.

What is claimed is:

1. A system comprising:
at least one computing device, and
program instructions stored on a non-transitory computer readable medium that, when executed by the at least one computing device, cause the at least one computing device to:
receive input data in the form of at least one search criterion indicative of a data landscape;
query an electronic database based at least in part on the input data;
retrieve a data list from the electronic database based at least in part on the query;
count data with common player names from the data list;
sort by count to generate a discrete distribution;
apply power law analysis to the discrete distribution to determine the value of an exponent S of the discrete distribution; and
use the exponent S as a metric of consolidation of the data list.

2. The system according to claim 1 wherein said metric is stored in a lossy compressed database version of said original electronic database.

3. The system according to claim 2 wherein the program instructions further cause the at least one computing device to generate the lossy compressed database version based at least in part on the application of a compression algorithm to the data list.

4. The system according to claim 3 wherein the compression algorithm is based at least in part on a Pareto distribution.

5. The system according to claim 4 wherein the compression algorithm is based at least in part on a power law transformation of the Pareto distribution.

6. The system of claim 1 wherein said database is a publication landscape.

7. The system according to claim 1 wherein at least one additional metric is determined, the at least one additional metric comprising one or more of a top ranked player dominance and a landscape scale.

8. The system according to claim 7 wherein said at least one additional metric is visualized graphically on a graphical display device.

9. The system of claim 8 wherein said visualization comprises a graph in which on one axis said metric of landscape consolidation is plotted and on the other axis said metric of landscape scale is plotted.

10. The system of claim 9 wherein said metric of landscape scale is plotted logarithmically on said axis.

11. The system of claim 8 wherein all three of said metrics are visualized graphically.

12. The system of claim 8 wherein said search criteria include date ranges and said visualization is a graph with one of said metrics on one axis and date or time on the other axis.

13. The system of claim 8 wherein said search criteria include date ranges and said visualization is a graph with one of said metrics on one axis and another of said metrics on a second axis.

14. A method of analysis of a database by a computing device, including:
receiving input data in the form of at least one search criterion indicative of a data landscape;
querying an electronic database based at least in part on the input data;
retrieving a data list from the electronic database based at least in part on the query;
counting data with common player names from said data list;
sorting by count to generate a discrete distribution;
applying power law analysis to said discrete distribution to determine the value of an exponent S of said discrete distribution; and
using said exponent S as a metric of consolidation of said database.

15. The method of claim 14 wherein said database is a publication database.

16. The method according to claim 14 wherein at least one additional metric is determined, the at least one additional metric comprising one or more of a top ranked player dominance and a landscape scale.

17. The method according to claim 16 wherein said at least one additional metric is visualized graphically on a graphical display device.

18. The method of claim 17 wherein said visualization is a graph in which on one axis said metric of landscape consolidation is plotted and on the other axis said metric of landscape scale is plotted.

19. The method of claim 18 wherein said metric of landscape scale is plotted logarithmically on said axis.

20. The method of claim 18 wherein all three of said metrics are plotted graphically.
